(19) United States
(12) Patent Application Publication
(10) Pub. No.: US 2024/0392761 A1
(43) Pub. Date: Nov. 28, 2024

(54) AIR-BREATHING PLASMA JET ENGINE

(71) Applicant: GEORGIA TECH RESEARCH CORPORATION, Atlanta, GA (US)

(72) Inventors: Lukas GRABER, Atlanta, GA (US); Adele PAYMAN, Oak Park, CA (US); Maryam TOUSI, Atlanta, GA (US); Amanda WEST, Atlanta, GA (US); Zhiyang JIN, Decatur, GA (US)

(21) Appl. No.: 18/696,665

(22) PCT Filed: Sep. 30, 2022
(86) PCT No.: PCT/US2022/045425

§ 371 Date: Mar. 28, 2024

Related U.S. Application Data
(60) Provisional application No. 63/251,167, filed on Oct. 1, 2021.

(51) Int. Cl. F03H 1/00; B64G 1/40

(52) U.S. Cl. CPC F03H 1/0012; F03H 1/0087; B64G 1/4005; B64G 1/413

(57) ABSTRACT

Exemplary air breathing plasma jet engine and method of operation that can be used in electrically powered aircraft and spacecraft as a hybrid between a turbo jet engine and a ramjet or supersonic sonic ramjet (SCRAMJET) engine. The air breathing plasma jet engine includes a compression stage that is configured to compress and slow down incoming air. The compressor can be driven by a high RPM electric motor. The compression stage generates compressed and heated air flow that is passed to a plasma chamber that is configured to add heat to the compressed and heated air flow. The heat are converted to an impulse, e.g., using a converging-diverging (De Laval) nozzle. The system is beneficially configured to reuse the heat byproduct generated in the compression stage.

### RELATED APPLICATION

This PCT application claims priority to, and the benefit of, U.S. Provisional Patent Application No. 62/251,167, filed Oct. 1, 2021, entitled “AIR-BREATHING PLASMA JET ENGINE,” which is incorporated by reference herein in its entirety.

### BACKGROUND

There is a benefit to having supersonic electric aircraft with high efficiency and reliability. Electric propulsion systems that use electricity can offset the use of hydrocarbons for air travel or cargo transportation. Electric vehicle propulsion is commonly performed using electric motors to convert electrical energy into rotational torque. For example, aerial vehicles that use electrical propulsion can use electric motors to turn propellers or ducted fans that produce thrust.

Rotating propellers or fans can produce thrust but face similar limitations relating to low gravimetric and/or volumetric power density, limited speed range, and supersonic effects.

Conventional turbo jet engines may employ a compression stage with a combustion chamber to generate thrust. At the output of the combustion chamber is a turbine stage that is mechanically linked via a rotating shaft to the compression stage.

Subsonic combustion engines such as ramjet or aero thermodynamic ducts employ a combustion chamber that injects and combusts fuels to output through a De Laval nozzle to convert heat and pressure into impulse. Supersonic combustion, such as SCRAMJET, employs a complex combustion chamber design configured with special fuel injectors to output through a divergent nozzle that can convert heat into impulse.

There are nevertheless benefits to improving engines.

### SUMMARY

Exemplary air-breathing plasma jet engine and method of operation are disclosed that can be used in electrically powered aircraft and spacecraft as a hybrid between a turbojet engine and a ramjet or supersonic sonic ramjet (SCRAMJET) engine. Similar to a turbojet engine, the air-breathing plasma jet engine includes a compression stage that is configured to compress and slow down incoming air. The compressor can be driven by a high RPM electric motor. The compression stage generates compressed and heated airflow that is passed to a plasma chamber that is configured to add heat to the compressed and heated airflow. The heat is converted to an impulse, e.g., using a converging-diverging (De Laval) nozzle. The system is beneficially configured to reuse the heat byproduct generated in the compression stage.

For higher speed operation, a bladeless configuration may be employed similar to RAMJET engines. The air-breathing plasma jet engine may employ a compression ratio higher than for conventional turbojet engines.

In an aspect, an air-breathing plasma jet engine is disclosed comprising an inlet configured to receive input air; a compressor stage coupled to the inlet, the compressor being configured to compress the input air and reduce input air velocity between an entry section of the compressor stage and an exit section of the compressor section; a plasma chamber operatively coupled to the compressor stage to receive compressed air from the compressor stage, the plasma chamber comprising a set of electrodes configured to generate an electric arc to convert the compressed air to an electrically conductive plasma; and a nozzle stage coupled to the plasma chamber, the nozzle stage being configured to expand the electrically conductive plasma and heated air to generate impulse.

In some embodiments, the compressor stage is configured with a radial compressor, the radial compressor comprising airfoils or blades configured to rotate to move gas or working fluid non-parallel to an axis of rotation of the airfoils or blades.

In some embodiments, the compressor stage is configured with an axial compressor, the axial compressor comprising airfoils or blades configured to rotate to move gas or working fluid parallel to an axis of rotation of the airfoils or blades.

In some embodiments, the compressor stage comprises a gearbox configured to rotate the airfoil or blade at speed greater than 4,000 revolutions per minute (e.g., 4 RPM and 10 K RPM).

In some embodiments, the compressor stage comprises an electric motor configured to rotate the airfoil or blade at speed greater than 50,000 revolutions per minute (e.g., 50K RPM and 200K RPM).

In some embodiments, the compressor stage is configured to provide a compression ratio greater than 10 (e.g., between a compression ratio of 10-60).

In some embodiments, the engine is mounted on an aircraft.

In some embodiments, the compressor stage is configured to generate heat, wherein at least half of the heat generated at the compressor stage is passed to the plasma chamber to be combined with heat generated there at, wherein the heat generated at the compressor stage and the heat generated at the plasma chamber contribute to the impulse generation.

In some embodiments, the compressor stage comprises an airflow channel defined by a first outer diameter region and a second outer diameter region, wherein the second outer diameter region has a smaller diameter than the first outer diameter region, and where the electric motor is located in the second outer diameter region.

In some embodiments, the compressor stage comprises an airflow channel defined by a first outer diameter region and a second outer diameter region, wherein the electric motor comprises coils located around the compressor stage and outside the airflow channel.

In some embodiments, the engine is mounted on a rocket.

In some embodiments, the engine is mounted into a wing of an aircraft.

In some embodiments, the engine further includes a coil system coupled to the plasma chamber, wherein the coil system is configured to generate a magnetic field to confine plasma generated in the plasma chamber.

In some embodiments, the plasma chamber includes an electrode to introduce inductively-coupled plasma currents to the plasma currents of the plasma chamber.

In some embodiments, the plasma chamber includes a film cooling system (e.g., for cooling the chamber walls, the nozzle, or the electrodes), a boil-off cooling system (e.g., for cooling or pre-heating the incoming air), or a heat exchanger (e.g., for cooling or pre-heating the incoming air).

In some embodiments, the nozzle stage comprises a convergent-divergent nozzle (e.g., De Laval nozzle) configured to convert the output heat and pressure into the impulse.

In another aspect, a method is disclosed comprising receiving, in an engine, input air; compressing, at a first stage of the engine, the input air and reducing input air velocity to generate compressed air; converting the compressed air to an electrically conductive plasma at a second stage of the engine configured to generate an electric arc in an airflow stream of the compressed air; and expanding the electrically conductive plasma to generate impulse of the engine, wherein at least half of the heat introduced at the first stage of the engine is combined with heat generated at the second stage to contribute to the impulse generation.

In another aspect, a system is disclosed for testing a plasma chamber thruster, the system comprising a test instrument; a plasma chamber thruster comprising an air moving stage; a plasma chamber operatively coupled to the air moving stage to receive compressed air, the plasma chamber comprising at least one electrode configured to generate an electric arc to convert the compressed air to an electrically conductive plasma; and a nozzle operably connected to the plasma chamber, wherein the test instrument is configured to measure a parameter associated with the nozzle or the plasma chamber.

In some embodiments, the test instrument comprises a load cell operatively connected between a test surface and the air-breathing plasma jet engine.

In some embodiments, a source of compressed air is connected to the air moving stage.

### BRIEF DESCRIPTION OF THE DRAWINGS

The skilled person in the art will understand that the drawings described below are for illustration purposes only.

FIGS. 1A, 1B, and 1C each illustrates a block diagram of an air-breathing plasma jet engine in accordance with an illustrative embodiment.

FIG. 2 illustrates an air-breathing plasma jet engine integrated into an aircraft wing, in accordance with an illustrative embodiment.

FIG. 3 illustrates a converging/diverging nozzle in accordance with an illustrative embodiment.

FIG. 4 illustrates an experimental wind tunnel to study electric arcing in high-speed airflow in accordance with an illustrative embodiment.

FIG. 5 illustrates an experimental plasma chamber in accordance with an illustrative embodiment.

FIG. 6A illustrates a side view of an experimental plasma chamber in accordance with an illustrative embodiment.

FIG. 6B illustrates a perspective view of an experimental plasma chamber in accordance with an illustrative embodiment.

FIG. 7 illustrates a block diagram of an experimental fixture including a plasma chamber in accordance with an illustrative embodiment.

FIG. 8 illustrates views of an experimental air-breathing plasma jet engine in accordance with an illustrative embodiment.

FIG. 9 illustrates a table of design parameters for a set of example air-breathing plasma jet engine or demonstrator, in accordance with illustrative embodiments.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

Future electric aircraft with supersonic cruising capability will require new types of electric engines that achieve high efficiency, power density, and reliability at low cost. Electric ducted fans have limitations in the supersonic flight regime. New types of air-breathing plasma jet engines could overcome these obstacles and provide a scalable solution for both subsonic and supersonic flight.

Embodiments of the present disclosure include air-breathing plasma jet engines. The air-breathing plasma jet engines can include (i) turbojet engine technology and electric propulsion. The combination of turbojet engine technology and electric propulsion can enable embodiments of the present disclosure to achieve: (i) supersonic flight at high gravitational and volumetric power density and/or (ii) a reduced carbon footprint and lower operating costs.

In addition to providing higher power density and higher efficiency as compared to electric ducted fans, the exemplary air-breathing plasma jet engine can be employed in distributed propulsion having higher aerodynamic efficiency. In some embodiments, the exemplary system can be configured with (i) an intake stage distributed along the leading edge of the wing, (ii) a compressor stage comprising a radial type with a horizontal axis, (iii) a plasma chamber stage built in the body of the wing, and (iv) a nozzle stage comprising the trailing edge of the wing as part of the expanding section. The exemplary system can be configured with integrating control surfaces, such as ailerons, flaps, and flaperons, directly into the nozzle design

### Example System

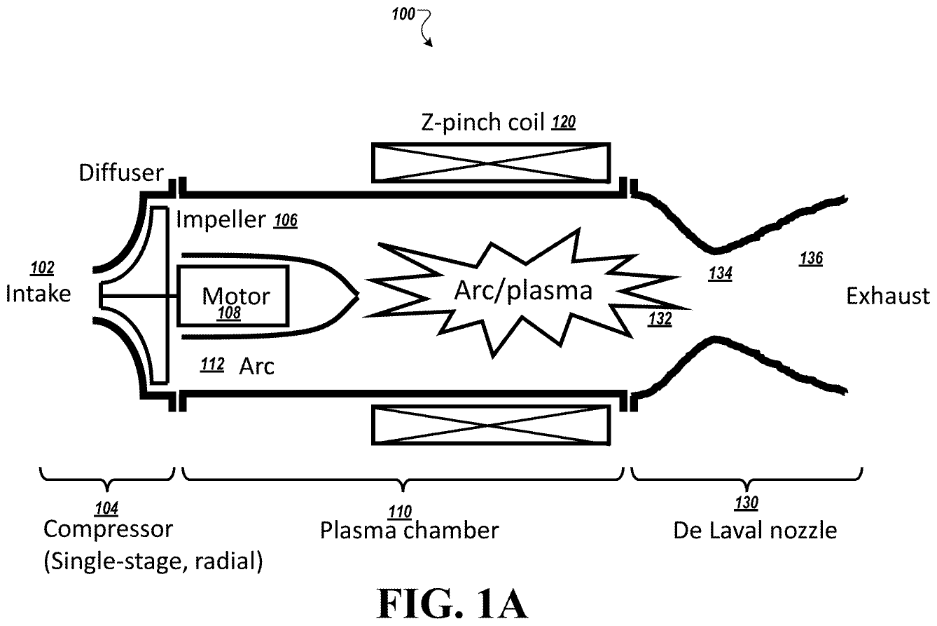

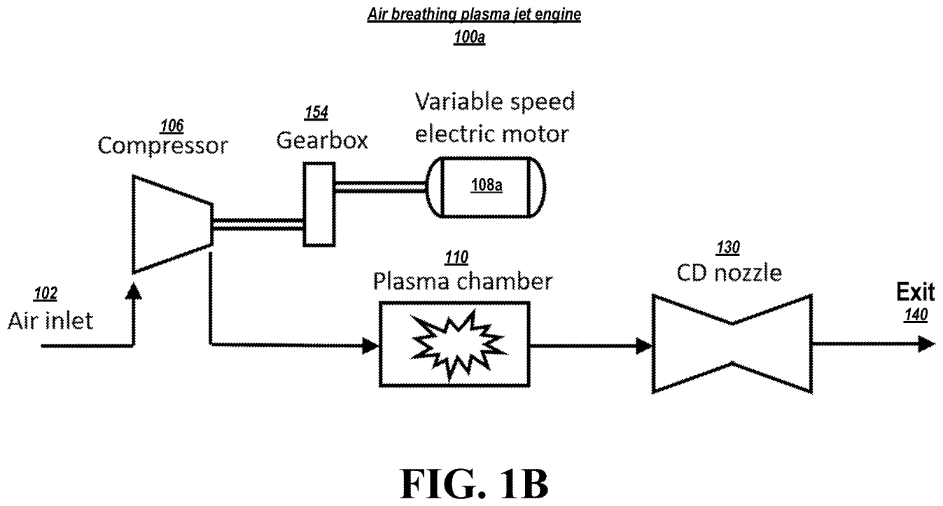

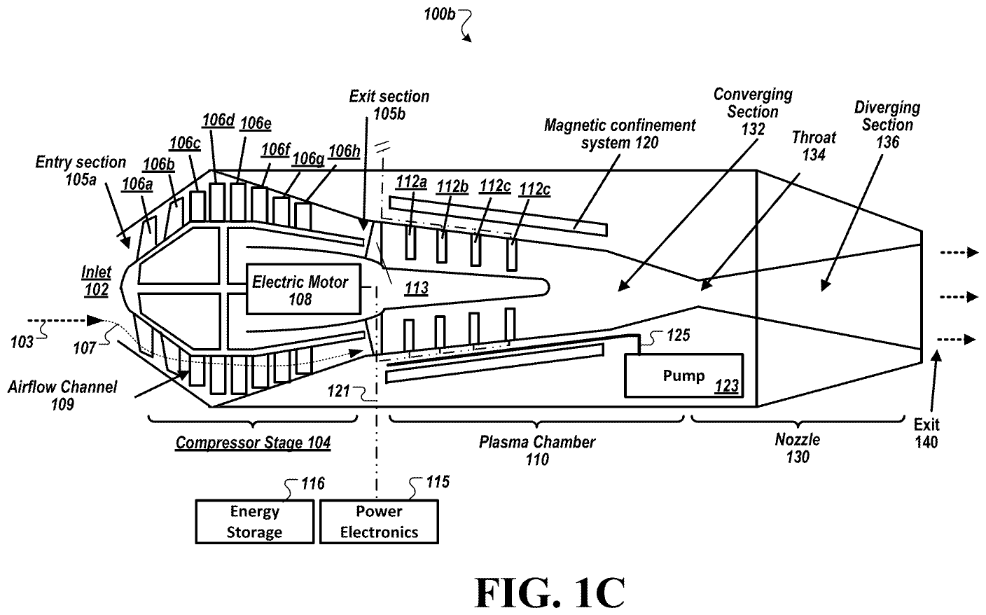

With reference to FIG. 1A, an example embodiment of an air-breathing plasma jet engine 100 is shown. The air-breathing plasma jet engine 100 includes a compression stage 104 configured with an electric motor 108, a plasma chamber 110, and a nozzle 130.

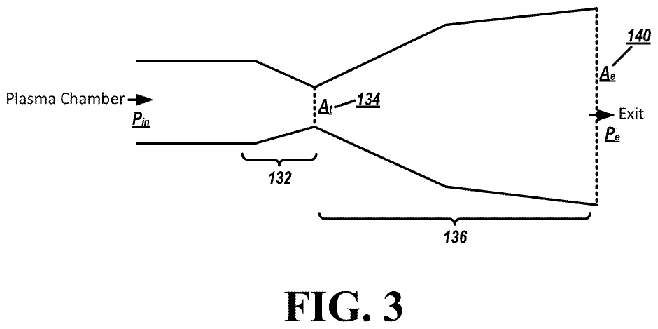

The air-breathing plasma jet engine 100 includes an inlet 102 (shown as “Intake” 102) configured to receive input air 103 (not shown, see FIG. 3). The inlet 102 can be in line with an axis of the compressor stage 104 (shown as “single-stage radial compressor” 104). The inlet 102 and compressor 104 are configured to increase the compression ratio and/or heating of the input air 103. Through the compression, the air is compressed and heated.

The air 103 from the inlet 102 enters the compressor stage 104 that is configured with one or more compressors 106 (shown as “Impeller” 106) driven by an electric motor 108 to compress the incoming air 103. The electric motor 108 includes a rotor and a stator, e.g., configured as a high-speed synchronous motor. In some embodiments, a stator is coupled to a gearbox. The electric motor 108 (and gearbox) may drive the compressor 106 at speed between 3,000 RPM and 200,000 RPM to provide a high compression ratio (e.g., 20:1, 60:1, 80:1, or higher). The electric motor 108 is preferably positioned in the engine 100. In other embodiments, the motor 108 can include coils (not shown) that are positioned outside the airflow channel 109.

For supersonic applications, the air inlet can contribute to the compression and heating of inlet air (similar to RAMJET, SCRAMJET operations).

The motor 108 may be coupled to a radial compressor, an axial compressor, or other compressor described herein. A radial compressor (e.g., centrifugal compressor) includes airfoils or blades configured to rotate to move gas or working fluid non-parallel to an axis of rotation of the airfoils or blades. An axial compressor include airfoils, impellers, or other blades configured to rotate to move gas or working fluid parallel to an axis of rotation of the airfoils or blades. Combinations of axial and radial compressors can be used to form the compressor stage 104 (e.g., a diagonal compressor, also referred to as a mixed flow compressor), and any number of axial and/or radial compressors can be used to form the compressor stage 104 (e.g., multiple compressors can be arranged in series to increase the amount of compression, or multiple compressors can be arranged in parallel to increase the airflow).

The compressor stage 104 is defined by an entry section 105a and an exit section 105b. The compressor stage 104 can both compress the input air and to reduce the input air velocity. That is, the air 107 at the exit section 105b of the compressor stage 104 is both slowed and compressed when compared to the air at the entry section 105a of the compressor stage 104. The compressor stage 104 includes an airflow channel 109. Alternatively, the motor 108 can be positioned outside the airflow channel 109.

The plasma chamber 110 is configured with (i) a set of electrodes 112 (shown as “Arc” 112) configured to introduce inductively-coupled plasma currents as heat into the chamber 110 by ionizing the compressed air from the compressor 106 and (ii) a thermal cooling or isolation system 120 (shown as “Z-pinch coil” 120), e.g., magnetic containment system to generate a magnetic field to confine plasma generated in the plasma chamber. Notably, the heat generated at the compressor stage 104 due to the compression of the input air 103 can pass to the plasma chamber 110 and be combined with heat introduced therein. Heat from the electrodes 102 and heat from the compressed air are combined in the plasma chamber 110 to a super-high temperature (e.g., 2000° K-3000° K) to form plasma. To withstand the high temperature, magnetic containment system 120 may be employed to insulate the heat from the interior surface of the chamber 110. Secondary cooling, e.g., film cooling, boil-off cooling, or conventional vein cooling (heat exchanger) in turbojet systems may be employed to regulate the surface temperature of the chamber 110. To withstand the high temperature and corrosion from the air, the electrodes may be made of pure nickel, pure copper, or a copper-based metal matrix composite material, e.g., for example, copper-tungsten, copper-tungsten carbide, chromium copper, or tungsten carbide silver.

The electrodes 112 may be supplemented with other heat sources, e.g., a microwave generator or an inductively-couple AC heater configured to direct microwave radiation into the plasma chamber to further heat the air.

The plasma chamber 110 is fixably coupled to the nozzle 130 (also referred to as a nozzle stage). The nozzle stage 130 is configured to increase the velocity of the escaping air as the air passes from the converging section 132 to the exit 140 by converting the heat and compressed air into the impulse of the air-breathing plasma jet engine. The nozzle 130 includes a convergent portion 132, a throat region 134, and a divergent portion 136. An example of a convergent-divergent nozzle is a De Laval nozzle. The throat 134 is narrower than the converging 132 and diverging sections 134. The nozzle stage 130 can further include bleed-air cooling, ablative cooling, regenerative cooling, and/or magnetic confinement. Example geometries for the diverging section 136 of the nozzle 130 include conical, parabolic, and bell geometries. Similar to a rocket engine nozzle, nozzle 130 is a propelling nozzle that can expand and accelerate combustion products to high supersonic velocities.

Embodiments of the present disclosure can be used in electric aircraft. The system may also be used to launch vehicles into space (e.g., as part of a single-stage-to-orbit vehicle).

As an example for a small-scale demonstrator (e.g., 300 kW engine), the impeller may employ a Garrett type G25-550 configured to operate at an impeller speed between 120 Krpm and 180 Krpm, that can provide 2.3 Nm impeller torque at 120 Krpm, 160-320 g/s impeller mass flow, with a compression ratio of 2.5-3.5. In transitioning to a full-scale engine or larger-scale demonstrator, the compression ratio can be increased, and the rotation speed can be reduced with larger blades and a greater number of compression stages.

In the small-scale demonstrator, the system may be configured with 2.24 kW arc heating, e.g., via Cu, W, or CuW/AgWC electrodes, that provides output to a nozzle having a 4.23 nozzle area ratio (A/A*), a 20°-30° convergent portion and a 15° divergent portion. Calculations in Tables 2, 3, 4 provide for an example of small and two examples of full or medium scale system.

Functional Diagram. FIG. 1B illustrates a functional block diagram of another embodiment of an air-breathing plasma jet engine 100 (shown as 100a) in accordance with another illustrative embodiment.

The air-breathing plasma jet engine 100a includes a variable speed electric motor 108 (shown as 108a) configured coupled to a gearbox 154 to drive the speed of the electric motor 108a to the prescribed speed between 3,000 RPM and 200,000 RPM. The gearbox 154, in turn, is coupled to the compressor 106.

### Example System #2

FIG. 1C shows another example embodiment of an air-breathing plasma jet engine 100 (shown as 100b). The air-breathing plasma jet engine 100b includes a compression stage 104 coupled to an electric motor 108, a plasma chamber 110, and a nozzle 130.

Multiple stage compressor 106 (shown as 106a-106h), similar to a conventional turbojet engine, may be employed. Multiple compressors 106 can increase the cost of the system and its maintenance. A trade-off between cost from a number of compressor stages and the rotating speed and resulting air velocity can be made while providing the prerequisite compression ratio (e.g., 20:1, 60:1, 80:1, or higher). Higher air velocity can attribute to corrosion of the electrodes 112 located downstream to the compression stage 104. Heat generated from the compression, while typically considered as a byproduct of the compression is intentionally captured and reused in the plasma chamber 110 to be used to ultimately generate thrust. In the example shown in FIG. 1C, 8 compressor stages are shown. The air-breathing plasma jet engine 100b may have 2, 3, 4, 5, 6, 7, or 8 stages. Unlike a conventional turbojet engine, the plasma chamber 110 is configured to direct compressed heated air out of the nozzle. No turbine section is employed in the later stage of the plasma chamber, which is superheated, to generate the thrust.

In the example shown in FIG. 1C, the electric motor 108 is housed in the front central section of the engine 100. The central section may be fixably attached to the engine 100 by load-bearing structures 113, which may be configured as stationary fins or air guides.

Multiple stages of the electrodes 112 (shown as 112a, 112b, 112c, and 112d stages) may be employed, each configured to ionize the compressed air outputted from the compression stage 104 to introduce inductively-coupled plasma currents as heat into the chamber 110.

The electric motor 108 and electrodes 112 may be operatively coupled, via cables 121, to two or more power electronic modules 115. A first set of one or more power electronic modules is configured to drive the electric motor 108. A separate power electronic module(s) are configured to drive the electrodes 112. Each stage of the electrodes may include 1, 2, 3, 4, 5, 6, 7, 8, 9, 10, 11, 12 number of electrodes. The power electronic modules 115 are operatively coupled to energy storage 116 (e.g., batteries). The power electronic module 115 may be positioned in the engine 100, or it may be positioned in other regions of the aircraft (e.g., in the wing).

Cooling, e.g., film cooling, boil off cooling, or conventional vein cooling (heat exchanger) in turbo jet systems may be employed to regulate the surface temperature of the chamber 110. In FIG. 1C, the engine 100b includes a pump 123 coupled to heat exchanging veins 125 that are built into the housing of the plasma chamber 110.

### Example System #3

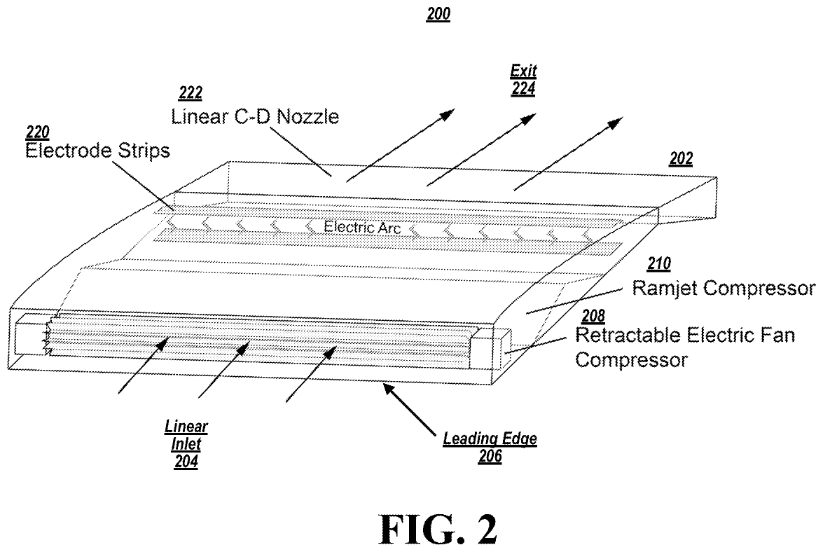

FIG. 2 illustrates an alternative embodiment of an air-breathing plasma jet engine 100 (shown as 200) configured to be integrated into a wing 202 of an aircraft. The air-breathing plasma jet engine 200 includes linear components that can run laterally through a wing 202. A linear inlet 204 is formed in at least part of the leading edge 206 of the wing 202. A retractable electric fan compressor 208 is positioned in the linear inlet 204 and configured to compress the air from the linear inlet. The air-breathing plasma jet engine 200 can also include a ramjet compressor 210 further configured to compress air from the inlet.

The compressed air from the ramjet compressor 210 and/or retractable electric fan compressor 208 can be heated. In the example embodiment shown in FIG. 2, electrode strips 220 are used to heat the compressed air. However, the electrode strips 220 are intended as non-limiting examples, and a microwave generator, radiofrequency generator, and/or inductively-couple AC heater can be used in addition to the electrode strips 220 or in alternative to the electrode strips 220.

The compressed and heated air can pass through a linear converging-diverging nozzle 222, which can increase the speed of the compressed and heated air that passes through the exit 224 of the air-breathing plasma jet engine.

### Example Nozzle Stage

FIG. 3 illustrates a perspective view of a nozzle stage 130 (shown as 130a) of an air-breathing plasma jet engine 100 of FIG. 1A, 1B, or 1C. The nozzle stage 130a is configured as a converging-diverging nozzle that includes a converging section 132, a throat 134, a diverging section 136, and an exit 140.

In the diagram, the plasma engine 110 is configured to generate high-pressure gas, Pin (302), which enters the converging section 132 of the nozzle stage 130. The high-pressure gas passes through the throat 134 having a throat area Aₜ to the diverging section 136, where the high-pressure gas expands the pressure drops to the pressure exit Pₑ at exit 140.

Table 1A shows example equations for a De Laval nozzle, including mass flow \dot{m}, area relation 1/ε, velocity relation Vₑ, and thrust T.

TABLE 1A

```
Mass flow rate relation for chocked flow;
  $\dot{m} = {\frac{{A}_{t} {P}_{in}}{\sqrt{{RT}_{in}}} [ {γ ( \frac{2}{γ + 1} )}^{\frac{γ + 1}{γ - 1}} ]}^{1 / 2} ; \dot{m} = ρ \times v \times A = ρ \times {v}_{F}$
Area relation (Nozzle area ratio-pressure ratio relation
    $\frac{1}{ε} ≡ \frac{{A}_{t}}{{A}_{e}} = {( \frac{γ + 1}{2} )}^{\frac{1}{γ - 1}} {( \frac{{P}_{e}}{{P}_{in}} )}^{\frac{1}{γ}} {\{ ( \frac{γ + 1}{γ - 1} ) [ 1 - {( \frac{{P}_{e}}{{P}_{in}} )}^{\frac{γ - 1}{γ}} ] \}}^{\frac{1}{2}}$
Velocity relation
      ${V}_{e} = {\{ \frac{2 γ}{γ - 1} \cdot \frac{{RT}_{in}}{{M}_{w}} \cdot [ 1 - {( \frac{{P}_{e}}{{P}_{in}} )}^{\frac{γ - 1}{γ}} ] \}}^{\frac{1}{2}}$
Thrust equation
        T = \dot{m}Vₑ + (Pₑ − Pₐ)Aₑ
```

For a set of values for gas density ρ, volumetric flow ν_{F}, specific heat ratio γ, atmospheric pressure Pₐ, exit pressure Pₑ, input pressure to throat Pᵢₙ, plasma chamber temperature Tᵢₙ, universal gas constant R, and molar mass M_{w}, the mass flow \dot{m}, area relation 1/ε, velocity relation Vₑ, and thrust T can be calculated.

### Experimental Results and Additional Examples

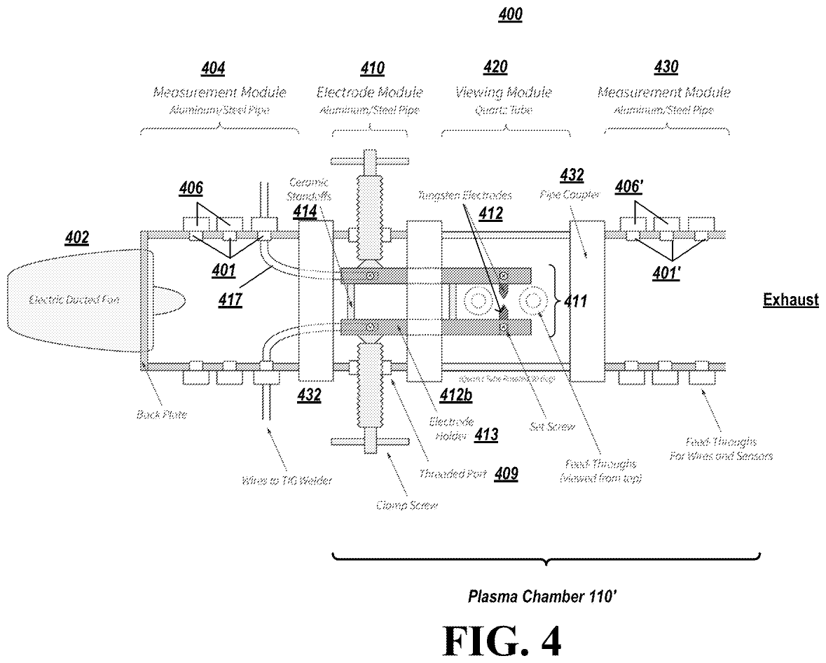

A study was conducted to evaluate aspects of the air-breathing plasma jet engine, including the thrust generation and the electrode. FIG. 4 is a diagram illustrating a test setup 400 to study electric arcing in high-speed airflow in accordance with an illustrative embodiment.
Example Demonstrator #1. The test setup 400 includes an electric ducted fan (EDF) 402 configured to provide compressed air in the intake of the experiment. The test setup 400 includes a first measurement module stage 404 mounted at a section after the EDF 402. The first measurement module stage 404 includes a set of sampling ports 401 that are configured with sensors 406 to measure pressure, temperature, and vibration. Examples of sensors 406 include temperature detectors, air pressure sensors, and Eddy-Current or Capacitive Displacement sensors.

The electrode module 410 is configured as a retainer member to fixably retain the electrode assembly 411 in the plasma chamber 110. The electrode assembly 411 includes a set of electrodes 412 that will be energized during the test to ionize compressed air provided by the electric ducted fan 402 to form the plasma or hot gas. In FIG. 4, the electrode module 410 is shown as a clamp screw that is attached to the plasma chamber assembly through a set of treaded ports 409. Other mounting assemblies may be used, e.g., bolts, retaining structures, etc.

The electrode assembly 411 includes electrode holders 413 (as a conduction bus bar), spaced apart by ceramic standoffs 414, that house the electrodes 412 (shown in the example as Tungsten-based electrodes). The electrodes are reconfigurable and are fixably held to the electrode holders 413 via set screws.

The electrode holder 413 is connected to cables 417 that may be instrumented to a TIG welder or other suitable power supply.

The test setup 400 includes a second measurement module stage 430 mounted at a section after the plasma chamber 110′. The second measurement module stage 430 includes a set of sampling ports 401′ that is configured with sensors 406′ to measure pressure, temperature, and vibration. The sensors 406′ are configured to operate at a higher pressure and higher temperature compared to that of sensors 406 of the first measurement module stage 404.

Experimental embodiments of the present disclosure can be operated without an electric ducted fan 402 and, alternatively, can receive air from external sources of air. Some non-limiting sources of air include compressed air canisters, air compressors, and/or wind tunnels (i.e., positioning the air-breathing plasma jet engine 400 so that the wind tunnel pushes air toward the electrode module).

The test setup 400 includes a viewing module 420 comprising a set of quartz tube 419, or other heat-resistant translucent material, to allow viewing, monitoring, sensing, measuring, etc., of the electrodes 412 and generated arc during an experiment.

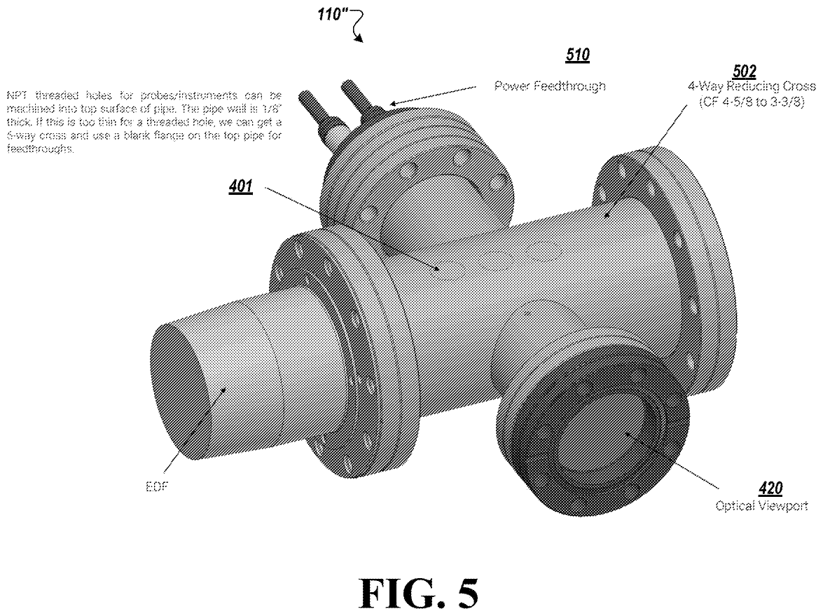

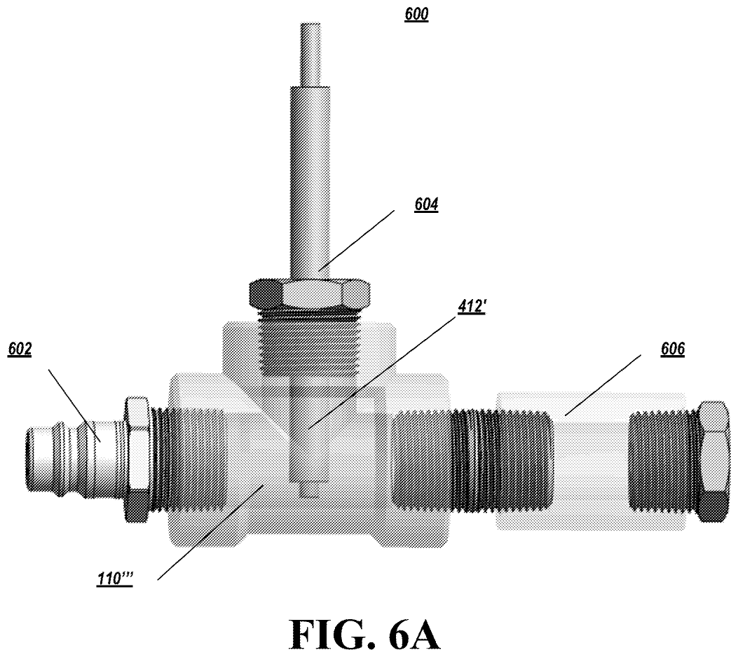

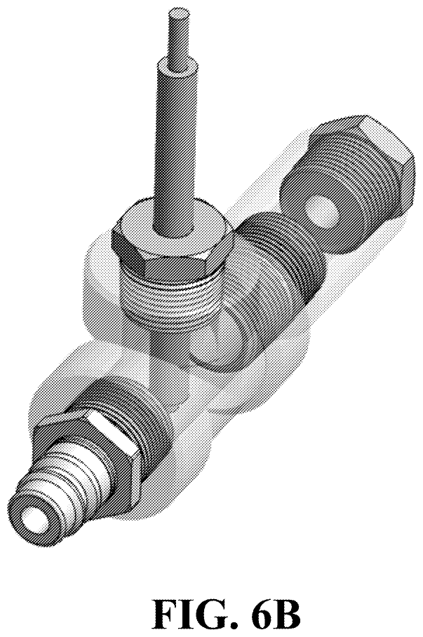

The test setup 400 may be manufactured of cast aluminum and/or steel pipe sections. Interior surfaces may be polished to reduce air resistance and/or improve airflow and reduce turbulent flow. The test setup 400 may be manufactured in sections in which the sections are joined, at couplers 432, via bolts or other connectors. The test setup 400 may be instrumented to measure thrust.
Example Demonstrator #2. FIG. 5 is a diagram illustrating another configuration of a test setup for a plasma chamber 110 (shown as 110″). In the example shown in FIG. 5, the plasma chamber 100″ includes a longitudinal chamber 502, configured in a 4-way reducing cross, to receive the compressed air from one end. The 4-way reducing cross 502 includes an optical viewport 420, as one arm of the cross, for viewing/measuring the inside of the plasma chamber 500. The 4-way reducing cross 502 includes a power feedthrough 510, as the other arm, that are operably coupled to an electrode that is extended into the plasma chamber 100″. For instrumentation, the 4-way reducing cross 502 may include one or more sampling ports 401 adapted to receive instrumentation and sensor into the plasma chamber 100″ during operation. The holes of the sampling port 401 may be threaded to seal instruments (not shown) inside the plasma chamber during operation.
Example Demonstrator #3. FIGS. 6A and 6B show diagrams of another demonstrator system 600 (referred to as a thrust demonstrator), similar to that of FIG. 5. The demonstrator system includes a 3-arm plasma chamber 110 (shown as 110″) that includes an air intake portion 602, an electrode assembly region 604, and a nozzle region 606. FIG. 6B illustrates a perspective view of the demonstrator system of FIG. 6A.

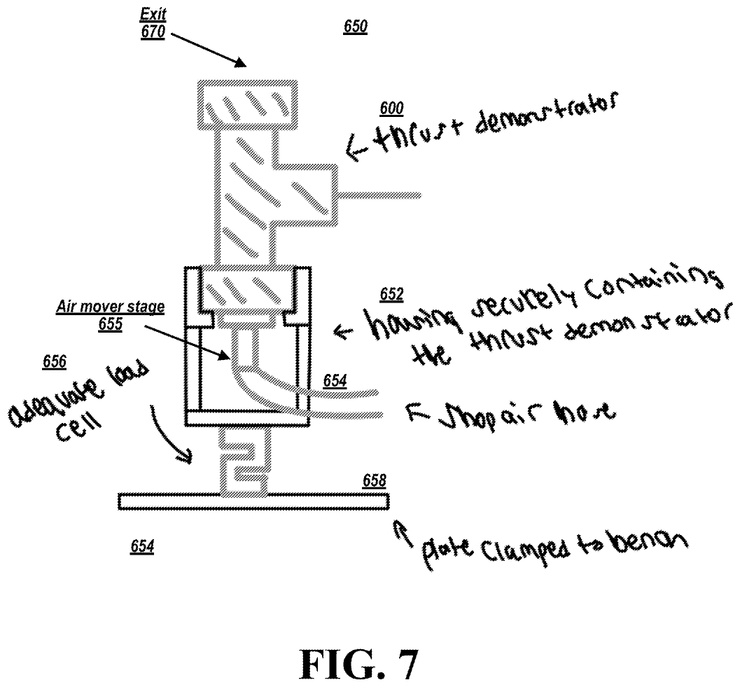

FIG. 7 shows a diagram of the demonstrator system 600 in a test fixture 650, as a plasma thruster, to evaluate thrust produced by the plasma chamber 110″. The test fixture 650 can be a system that includes a plasma thruster instead of an air-breathing plasma jet engine. The demonstrator system 600 is configured to operate in a stationary position (as opposed to a jet engine, which is configured to intake air by moving through the air). The test fixture 650 includes a housing 652 to receive the demonstrator system 600.

The housing 652 is fixably mounted into a load cell 656 so that when the plasma chamber 600 is operational, air escapes the exit 670 of the plasma chamber 600 and generates thrust that presses the plasma chamber 600 against the housing 652, and, in turn, the housing 652 against the load cell 656. The load cell 656 is then compressed between the housing 652 and a surface 658 (e.g., a plate clamped to a workbench). The exit 670 may include a nozzle, e.g., as shown in FIG. 6B. The force measured by the load cell 656 may be used to determine the thrust produced by the plasma chamber 600. Additionally, the test fixture 650 can include other test instruments configured to measure different parameters of the plasma chamber 600, including volumetric flow ν_{F}, exit pressure Pₑ, input pressure to throat Pᵢₙ, and plasma chamber temperature Tᵢₙ, among others.

FIGS. 7A and 7B show an example configuration for a small-scale 300 kW demonstrator system. The demonstrator system may provide 160-320 g/s impeller mass flow as an input with a pressure ratio of 2.5-3.5 to the standard atmosphere. The demonstrator may employ a 240 kW arc heating module that can receive electrodes, e.g., made with W or CuW/AgWC.

Example embodiments of the present disclosure were designed and can be studied and evaluated using numerical analysis.

### Example #1: Design and Construction of Air-Breathing Plasma Jet Engine

An example embodiment of the present disclosure is described herein. The embodiment includes an ambient-pressure plasma chamber. The inlet velocity, the degree of turbulence, and the inlet temperature can be controlled. For example, an LN2 spray can be used to control the inlet temperature to the ambient pressure plasma chamber. The chamber can include a pair of electrodes, which can be oriented in different directions with respect to the airflow. Different diffusers can be introduced to vary the degree of turbulence in the airflow. The electrodes can form an arc, and the arc stability of under various flow conditions, wall heating, as well as electrode wear can all be measured to evaluate the performance of the ambient temperature plasma chamber.

The ambient-pressure plasma chamber can include coils to perform magnetic confinement (z-pinch). Additionally, the ambient pressure plasma chamber can include sensors. Non-limiting examples of sensors that can be deployed in/around the ambient pressure plasma chamber include temperature sensors, anemometers, optical emission spectrometers, and Langmuir probes.

The ambient-pressure plasma chamber can be used to implement an air-breathing plasma jet engine. The ambient-pressure plasma chamber can be modular and configured to be used as part of different air-breathing plasma jet engines. A modular ambient-pressure plasma chamber can be used to test different pressure ratios, methods of plasma generation, and cooling methods, which can be used by different air-breathing plasma jet engines that use the same ambient-pressure plasma chamber.

An example embodiment of the air-breathing plasma jet engine includes a single-stage radial compressor, a cylindrical plasma chamber, and a converging-diverging nozzle. The example embodiment can include sensors configured to measure thrust, pressure ratio, flow rate, temperatures, and electrical current and voltage.

The example embodiment can achieve a thrust of 100 N and a gas exhaust velocity of 430 m/s at a total electrical input power (compressor and plasma combined) of 25 kW or less.

As a non-limiting example, the air-breathing plasma jet engine can include a radial compressor approximately 60 mm in diameter. The radial compressor can achieve a pressure ratio of about 2.0-3.5 at about 75% efficiency and generate a mass flow rate from 160-320 grams per second. The rotational speed of the example radial compressor is approximately 120,000-180,000 rpm.

In the example embodiment, the radial compressor is an electric compressor. However, the system can also use a turbine driven by compressed air. A compressed air turbine can optionally be used as part of a test fixture to construct an experimental air-breathing plasma jet engine without requiring an electric motor capable of turning the compressor at 120,000-180,000 rpm.

### Example 2: Engine Sizes and Applications

Another example embodiment of the present disclosure is a 250-kN plasma jet engine. The example embodiment is approximately the size of a Pratt & Whitney PW1000G, used in the Airbus A320neo. The present disclosure also contemplates smaller-scale plasma jet engines can be constructed. Embodiments of the present disclosure can be used to perform boundary layer ingestion and thereby improve the efficiency of aircraft.

### Example 3: Thrust Vectoring

Example embodiments of the present disclosure can include thrust vectoring. In embodiments, including z-pinch coils, the magnetic field can be used to direct the engine thrust or to reverse the thrust without additional moving parts.

### Example 4: Heat and Plasma Management

Example embodiments of the present disclosure can produce intense heat in the plasma, which can radiate to other parts of the plasma chamber and/or air-breathing plasma jet engine. The plasma chamber and/or air-breathing plasma jet engine can be cooled using bleed-air cooling and/or evaporative cooling. Additionally, embodiments of the present disclosure can be configured so that the plasma is sufficiently separated from the walls of the plasma chamber to avoid overheating the plasma chamber. In some embodiments of the present disclosure, the z-pinch coil, plasma chamber, and/or plasma jet engine can be configured to maintain stable plasma conditions under high-speed flow conditions.

### Example 5: Additional Experimental Embodiments

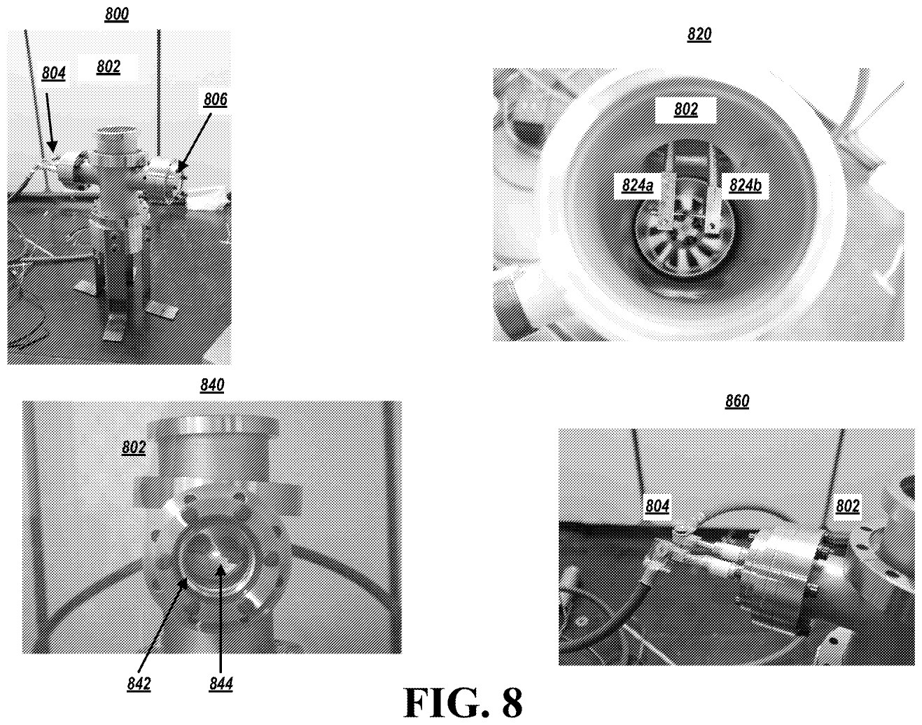

Experimental embodiments of the air-breathing plasma jet engine were built and tested. FIG. 8 illustrates views of an example experimental embodiment of the air-breathing plasma engine.

Panel 800 in FIG. 8 illustrates a perspective view of a plasma chamber 802, including electrical connections 804 and a viewing window 806.

Panel 820 in FIG. 8 illustrates the inside of the plasma chamber 802. The plasma chamber 802 includes two electrodes 824a, 824b.

Panel 840 in FIG. 8 illustrates a view of the plasma chamber 802 with a viewing window 806. An arc 844 is visible through the viewing window 842.

Panel 860 in FIG. 8 illustrates an electrical connection 804 for powering electrodes (not shown) inside the plasma chamber 802.

### Example 6: Design of a Nozzle for an Air-Breathing Plasma Jet Engine and or Plasma Thruster

A nozzle was designed for use with embodiments of the air-breathing plasma jet engine and/or plasma thrusters described with reference to FIGS. 1-8. Nozzle design calculations were performed using an isentropic model to create a table of example design parameters for three different nozzles configured to be used with different plasma chambers. Table 900 shows the design parameters for the example embodiments. Column 902 shows the design parameters for a small-scale air-breathing jet engine (referred to herein as a “demonstrator”). Column 904 shows the design parameters for a first embodiment of a full-scale air-breathing plasma jet engine. Column 906 shows the design parameters for a second embodiment of a full-scale air-breathing plasma jet engine. Standard isentropic flow tables were used for pressure, temperature, and area ratios.

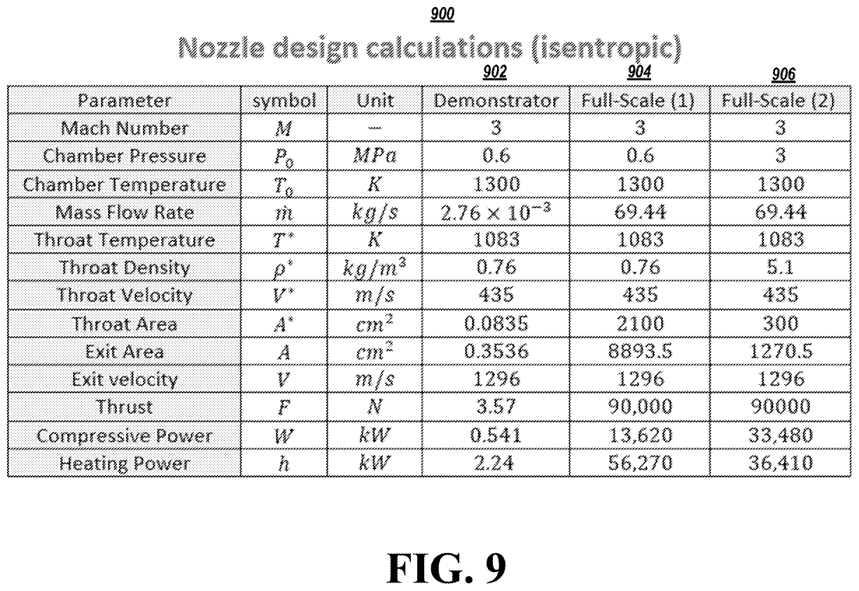

Calculation details for the small-scale air breathing jet engine. The results in table 900 illustrated in FIG. 9 for a small-scale demonstrator are calculated in Table 2 below for a mach (M)=3 operation.

TABLE 2
Fixed Parameters
initial chamber Pressure: P₀ = 6 × 10⁵ Pa
initial chamber temperature (Arc Temperature) T₀ = 1300° K
Mass flow rate (a typical air tool) m [symbol] 2.76 × 10⁻³ kg/s
Ratio of specific heat for air, γ = 1.4
gas constant, R = 287 J/(kg · K)
Mach number, M = 3.

| Parameters | Calculations |
|---|---|
| Throat temperature (T*) | $\frac{{T}_{0}}{T} = 1.2 where T = {T}^{*}$ |
| | $The temperature at throat \to {T}^{*} = \frac{1300}{1.2} = 1083 ° k$ |
| Throat density (ρ*) | $\frac{{ρ}_{0}}{ρ} = 1.577 where ρ = {ρ}^{*} ( Density of air at throat )$ |
| | ${ρ}_{0} = \frac{{P}_{0}}{{RT}_{0}} = \frac{6 \times {10}^{5}}{287 \times 1300} = 1.608 \frac{kg}{{m}^{3}} \to {ρ}^{*} = \frac{1.608}{1.577} = 0.76 \frac{kg}{{m}^{3}}$ |
| Throat area (A*) | $\dot{m} = {ρ}^{*} \cdot {V}^{*} \cdot {A}^{*} \to {A}^{*} = \frac{2.76 \times {10}^{- 3}}{435 \times 0.76} = 8.35 \times {10}^{- 6} {m}^{2} = 8.35 {mm}^{2} in which {A}^{*} = 8.35 {mm}^{2}$ |
| | For Square Cross section: d = 2.89 mm |
| | For circular cross section: A* = πr² → r = 1.63 mm |
| Throat velocity (V*) | ${V}^{*} = M \cdot \sqrt{γ \cdot R \cdot {T}^{*}} = \sqrt{1.4 \times 287 \times 1083} = 435 m / s \to {V}^{*} = 435 m / s$ |
| Exit area (A) | $\frac{A}{{A}^{*}} = 4.235 \to A = 35.36 {mm}^{2}$ |
| | For Square Cross section: d = 5.95 mm |
| | For circular cross section: A* = πr² → r = 3.35 mm |
| Exit Temperature | $\frac{{T}_{0}}{T} = 2.8 \to T = \frac{1300}{2.8} \to T ( exit ) = 464.28 ° K .$ |
| Thrust (F) | F = \dot{m} · V = 2.76 × 10⁻³ × 1296 → F = 3.57 (N) |
| Exit Velocity (V) | V= M · \sqrt{γ · R · T} = 3 × \sqrt{1.4 × 287 × 464} → V (exit) = 1296 m/s. |
| Compressive power | W = \dot{m}Cₚ(T₂ − T₁). |
| | $Isentropic : \frac{{T}_{2}}{{T}_{1}} = {( \frac{{P}_{2}}{{P}_{1}} )}^{\frac{γ - 1}{γ}} \to \frac{{T}_{2}}{293.5} = {( \frac{0.6}{0.1} )}^{\frac{1.4 - 1}{1.4}} \to {T}_{2} = 489.7 ( K ) in which W = \dot{m} {C}_{p} ( {T}_{2} - {T}_{1} ) = 2.76 \times {10}^{- 3} \times 1000 \times ( 489.7 - 293.5 ) ; W = 541.5 ( w )$ |
| Heating Power (heat flow rate) | $\dot{m} = \frac{h}{{C}_{p} \cdot dT} in which h : heat flow rate ( w ) ; h = 2.76 \times {10}^{- 3} \times 1000 \times ( 1300 - 489.7 ) ; h = 2.24 kW$ |

Calculation details for the first embodiment of a full-scale air-breathing jet engine. The results in table 900 illustrated in FIG. 9 for a first example full-scale air-breathing plasma jet engine 100 is calculated in Table 3 below for a mach (M)=3 operation.

TABLE 3
Fixed Parameters
Chamber Pressure: P₀ = 6 × 10⁵ Pa
Chamber Temperature (Arc Temperature): T₀ = 1300° K
Ratio of specific heat for air: γ = 1.4
Gas constant: R = 287 J/(kg · K)
Mach number: M = 3
Thrust: F = 90 kN

| Parameters | Calculations |
|---|---|
| Throat temperature (T*) | |
| Throat density (ρ*) | |
| Throat area (A*); | $\dot{m} = {ρ}^{*} \cdot {V}^{*} \cdot {A}^{*} \to {A}^{*} = \frac{69.44}{435 \times 0.76} = \frac{69.44}{330.6} = 0.21 {m}^{2} \to {A}^{*} = 2100 {cm}^{2}$ |
| | For Square Cross section: d = 45.83 cm |
| | For circular cross section: A* = πr² → r = 25.85 cm |
| Throat velocity (V*) | |
| Exit area (A) | $\frac{A}{{A}^{*}} = 4.235 \to A = 8893.5 {cm}^{2}$ |
| | For Square Cross section: d = 94.3 cm |
| | For circular cross section: A* = πr² → r = 53.21 cm |
| Mass flow rate (m) | F = 90 × 10³ = \dot{m} · V = \dot{m} × 1296 → \dot{m} = 69.44 kg/s |
| Exit Velocity (V) | |
| Compressive power | W = \dot{m}Cₚ(T₂ − T₁) |
| | $Isentropic : \frac{{T}_{2}}{{T}_{1}} = {( \frac{{P}_{2}}{{P}_{1}} )}^{\frac{γ - 1}{γ}} \to \frac{{T}_{2}}{293.5} = {( \frac{0.6}{0.1} )}^{\frac{1.4 - 1}{1.4}} \to {T}_{2} = 489.7 ( K )$ |
| | W = \dot{m}Cₚ(T₂ − T₁) = 69.44 × 1000 × (489.7 − 293.5) |
| | W = 13.62 (MW) |
| Heating Power (heat flow rate) | $\dot{m} = \frac{h}{{C}_{p} \cdot dT}$ |
| | h: heat flow rate (w) |
| | h = 69.44 × 1000 × (1300 − 775.61) |
| | h = 56.27 MW |

Calculation details for the second embodiment of a second full-scale air-breathing jet engine. The results in table 900 illustrated in FIG. 9 for a small-scale demonstrator are calculated in Table 4 below for a mach (M)=3.

The second embodiment includes a higher plasma chamber pressure (i.e., initial pressure) of 3 MPa as compared to the first embodiment, which assumed a plasma chamber pressure of 0.6 MPa. The throat area of a nozzle was calculated based on a 90 kN thrust.

TABLE 4
Fixed Parameters
Chamber Pressure: P₀ = 3 × 10⁶ Pa
Chamber Temperature (Arc Temperature): T₀ = 1300 °K
Ratio of specific heat for air: γ = 1.4
Gas constant: R = 287 J/(kg · K)
Mach number: M = 3
Thrust: F = 90 kN

| Parameters | Calculations |
|---|---|
| Throat temperature (T\hat{ }*) | |
| Throat density (ρ\hat{ }*) | $\frac{{ρ}_{0}}{ρ} = 1.577 in which ρ = {ρ}^{*} ( Density of air at throat ) ; {ρ}_{0} = \frac{{P}_{0}}{{RT}_{0}} = \frac{3 \times {10}^{6}}{287 \times 1300} = 8.04 \frac{kg}{{m}^{3}} = {ρ}^{*} = \frac{8.04}{1.577} = 5.1 \frac{kg}{{m}^{3}}$ |
| Throat area (A\hat{ }*); | $\dot{m} = {ρ}^{*} \cdot {V}^{*} \cdot {A}^{*} \to {A}^{*} = \frac{69.44}{435 \times 5.1} = \frac{69.44}{2218.5} = 0.03 {m}^{2} \to {A}^{*} = 300 {cm}^{2}$ |
| | For square cross-section: d = 17.32 cm |
| | For circular cross-section: A* = πr² → r = 9.77 cm |
| Throat velocity (V\hat{ }*) | |
| Exit area (A) | $\frac{A}{{A}^{*}} = 4.235 \to A = 1270.5 {cm}^{2}$ |
| | For square cross-section: d = 35.64 cm |
| | For circular cross-section: A* = πr² → r = 20.11 cm |
| Mass flow rate (m) | F = 90 × 10³ = \dot{m} · V = \dot{m} × 1296 → \dot{m} = 69.44 kg/s |
| Exit Velocity (V) | |
| Compressive power | W = \dot{m}Cₚ(T₂ − T₁) |
| | $Isentropic : \frac{{T}_{2}}{{T}_{1}} = {( \frac{{P}_{2}}{{P}_{1}} )}^{\frac{γ - 1}{γ}} \to \frac{{T}_{2}}{293.5} = {( \frac{3}{0.1} )}^{\frac{1.4 - 1}{1.4}} \to {T}_{2} = 775.61 K °$ |
| | W = \dot{m}Cₚ(T₂ − T₁) = 69.44 × 1000 × (775.6 − 293.5) |
| | W = 33.48 MW |
| Heating Power (heat flow rate) | $\dot{m} = \frac{h}{{C}_{p} \cdot dT} in which h : heat flow rate ( w ) , h = 69.44 \times 1000 \times ( 1300 - 775.61 ) ; h = 36.41 MW$ |

Discussion. It should be appreciated that other operating conditions for the air-breathing plasma jet engine may be employed, e.g., intended or desired Mach number, chamber pressure, chamber temperature, mass flow rate, throat temperature, throat air density, throat air velocity, throat area, exit area, exit velocity, thrust, compressive power, and heating power, e.g., using the disclosure and relations described herein.

The two full-scale systems with the 90 kN thrust are intended to be used, e.g., in an A320/B737 application, which requires such thrust levels. In the first full-scale system, the power is put more into the compressor, and the second system includes more power in the plasma. It is noted that in either scenario, the same total electrical power is provided (˜70 MW) for the same thrust and the same specific impulse (exit velocity). Indeed, heat generated from the compression stage and the plasma chamber stage in this system configuration is preserved and ultimately used for thrust. While the values are merely examples (isentropic) and are shown assuming sea level operation (e.g., 0.1 MPa ambient pressure, 300 K ambient temperature), the disclosure allows for them to be readily changed for any altitude of operation (e.g., 0-60000 ft).

The demonstrator (902) is scaled down for laboratory use and testing. With its power of 2.8 kW at a mass flow of 2.8 g/s, it is small but sufficient to produce a measurable thrust of 3.6 N. The system may operate using pressurized air provided through the facility (i.e., shop air).

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include one particular value and/or the other particular value.

By “comprising” or “containing” or “including,” is meant that at least the name compound, element, particle, or method step is present in the composition or article or method but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The following patents, applications and publications as listed below and throughout this document are hereby incorporated by reference in their entirety herein.

1. An air-breathing plasma jet engine comprising:
an inlet configured to receive input air;
a compressor stage coupled to the inlet, the compressor being configured to compress the input air and reduce input air velocity between an entry section of the compressor stage and an exit section of the compressor section;
a plasma chamber operatively coupled to the compressor stage to receive compressed air from the compressor stage, the plasma chamber comprising a set of electrodes configured to generate an electric arc to convert the compressed air to an electrically conductive plasma; and
a nozzle stage coupled to the plasma chamber, the nozzle stage being configured to expand the electrically conductive plasma and heated air to generate impulse.

2. The air-plasma jet engine of claim 1, wherein the compressor stage is configured with a radial compressor, the radial compressor comprising airfoils or blades configured to rotate to move gas or working fluid non-parallel to an axis of rotation of the airfoils or blades.

3. The air-plasma jet engine of claim 1, wherein the compressor stage is configured with an axial compressor, the axial compressor comprising airfoils or blades configured to rotate to move gas or working fluid parallel to an axis of rotation of the airfoils or blades.

4. The air-plasma jet engine of claim 1, wherein the compressor stage comprises a gearbox configured to rotate the airfoil or blade at a speed greater than 4,000 revolutions per minute.

5. The air-plasma jet engine of claim 1, wherein the compressor stage comprises an electric motor configured to rotate the airfoil or blade at a speed greater than 50,000 revolutions per minute.

6. The air-plasma jet engine of claim 1, wherein the compressor stage is configured to provide a compression ratio greater than 10.

7. The air-plasma jet engine of claim 1, wherein the engine is mounted on an aircraft.

8. The air-plasma jet engine of claim 1, wherein the compressor stage is configured to generate heat, wherein at least half of the heat generated at the compressor stage is passed to the plasma chamber to be combined with heat generated there at, wherein the at least half of the heat generated at the compressor stage and the heat generated at the plasma chamber contribute to the impulse generation.

9. The air-plasma jet engine of claim 5, wherein the compressor stage comprises an airflow channel defined by a first outer diameter region and a second outer diameter region, wherein the second outer diameter region has a smaller diameter than the first outer diameter region, and where the electric motor is located in the second outer diameter region.

10. The air-plasma jet engine of claim 5, wherein the compressor stage comprises an airflow channel defined by a first outer diameter region and a second outer diameter region, wherein the electric motor comprises coils located around the compressor stage and outside the airflow channel.

11. The air-plasma jet engine of claim 1, wherein the engine is mounted on a rocket.

12. The air-plasma jet engine of claim 1, wherein the engine is mounted into a wing of an aircraft.

13. The air-breathing plasma jet engine of claim 1 further comprising:
a coil system coupled to the plasma chamber, wherein the coil system is configured to generate a magnetic field to confine plasma generated in the plasma chamber.

14. The air-breathing plasma jet engine of claim 13, wherein the plasma chamber includes an electrode to introduce inductively-coupled plasma currents to the plasma currents of the plasma chamber.

15. The air-breathing plasma jet engine of claim 1, wherein the plasma chamber includes a film cooling system, a boil off cooling system, or heat exchanger.

16. The air-breathing plasma jet engine of claim 1, wherein the nozzle stage comprises a convergent-divergent nozzle configured to convert the output heat and pressure into the impulse.

17. A method comprising:
receiving, in an engine, input air;
compressing, at a first stage of the engine, the input air and reducing input air velocity to generate compressed air;
converting the compressed air to an electrically conductive plasma at a second stage of the engine configured to generate an electric arc in an airflow stream of the compressed air; and
expanding the electrically conductive plasma to generate impulse of the engine,
wherein at least half of the heat introduced at the first stage of the engine is combined with heat generated at the second stage to contribute to the impulse generation.

18. A system for testing a plasma chamber thruster, the system comprising:
a test instrument;
a plasma chamber thruster comprising:
an air moving stage;
a plasma chamber operatively coupled to the air moving stage to receive compressed air, the plasma chamber comprising at least one electrode configured to generate an electric arc to convert the compressed air to an electrically conductive plasma; and
a nozzle operably connected to the plasma chamber;
wherein the test instrument is configured to measure a parameter associated with the nozzle or the plasma chamber.

19. The system of claim 18, wherein the test instrument comprises a load cell operatively connected between a test surface and the air breathing plasma jet engine.

20. The system of claim 18, wherein a source of compressed air is connected to the air moving stage.
